(19) United States
(12) Patent Application Publication
(10) Pub. No.: US 2015/0220950 A1
(43) Pub. Date: Aug. 6, 2015

(54) ACTIVE PREFERENCE LEARNING METHOD AND SYSTEM

(71) Applicant: YAHOO! INC., Sunnyvale, CA (US)

(72) Inventor: JenHao Hsiao, Taipei (TW)

(73) Assignee: YAHOO! INC., Sunnyvale, CA (US)

(21) Appl. No.: 14/174,399

(22) Filed: Feb. 6, 2014

(51) Int. Cl. G06Q 30/02; G06N 99/00

(52) U.S. Cl. CPC G06Q 30/0203; G06N 99/005

(57) ABSTRACT

A relative labeling approach is disclosed to learn an item preference scoring function to rank items for a user. An iterative process may be used to present a set of items to a user in an interactive user interface, using which the user is asked to identify one of the items in the set that the user prefers over the other items in the set. Input received from the user may be considered to be a “labeling” of the items in the set relative to each other. Subsequent labeling input may be added to previous labeling input to generate an updated preference scoring function for the user. Selection of each item for inclusion in the set of items presented to the user may be based on a measure of the knowledge that may be gained by including the item in the set.

### FIELD OF THE DISCLOSURE

The present application relates to learning user preferences, and more particularly to collecting user item labeling input indicating relative item preferences using an interactive process and to learning a preference scoring function from one or more iterations of labeling input.

### BACKGROUND

Typical methods used for eliciting user preferences consist of questionnaires and ratings scales. The questionnaire provides the user with a number of items and the user indicates whether the user likes or dislikes each item. This approach requires a great deal of patience on the part of the user and limits the user's response to a simple binary response with regard to each item, i.e., yes or no, like or dislike, etc. A scaled ratings approach may be used to ask the user to evaluate an item by explicitly giving it a score based on a ratings scale, e.g., a score from 1 to 10, to indicate the user's preference. This approach creates confusion for the user as the user is likely to have difficulty quantifying what each value in a ratings scale means to the user, e.g., the user is likely to have difficulty determining the difference between the values of 7 and 8 in a ratings scale from 1 to 10. In addition and like the questionnaire approach, the ratings scale approach requires a great deal of patience on the part of the user.

### SUMMARY

The present disclosure seeks to address failings in the art and to provide a streamlined approach to determining a user's preferences. Embodiments of the present disclosure use a relative labeling approach to identify an item ranking, or ordering, function, which is also referred to herein as a preference scoring function, to rank items for a user, which function is able to generate a score for each item of a plurality of items based on the items' features and a learned weight associated with each feature.

In accordance with one or more such embodiments an iterative process may be used to present a set of items, k items, to a user in an interactive user interface. The user is asked to identify one of the items in the set, which the user prefers over the other items in the set. By way of some non-limiting examples, the user may be asked to select the user's favorite, or most preferred, item of the items in the set presented to the user in the user interface. Input received from the user may be considered to be a “labeling” of the items in the set presented to the user, where the selected item may be labeled as being preferred over the other items in the set and the other items may be labeled as being less preferred relative to the selected item.

The user may continue labeling until the user wishes to end the process. Each time the user provides labeling input, a ranking function may be generated that uses the labeling input received from the user thus far. The ranking function comprises a weighting for each item feature and is learned based on the user's labeling input. The set of items presented to the user may be selected from a collection of items based on a determination of the knowledge that may be gained from inclusion of an item in the set of items. By way of a non-limiting example, each item in the collection may be assigned a score relative to the other items in the collection; an item's score may be referred to as a knowledge gain score and may be indicative of an amount of knowledge gained if the item is included in the set of items. An item may be selected for the set of items based on its knowledge gain score relative to other items' knowledge gain scores. In accordance with one or more embodiments, the item selection may also be based on whether an item has already been labeled, e.g., already been included in a previous set of items presented to the user.

The ranking function identified using the labeling input provided by the user may be used to rank “unlabeled” items. By way of a non-limiting example, the ranking function may generate a preference score using the learned weights for the item features. An item's preference score may be compared to other items' preference scores for ordering items, and/or to identify one or more items preferred by the user relative to other items in a collection of items for which the ranking function is determined. Identification of a user's preferred item(s) may be used in any number of applications, including without limitation in making item recommendations to a user, personalizing a user's experience, targeted advertising, etc.

In accordance with one or more embodiments, a method is provided comprising receiving, by a computing device and via a user interface, user item labeling input in response to a first plurality of items presented in the user interface and indicating a user's preference for selected item relative to each other item of the first plurality; learning, by the at least one computing device, a preference scoring function comprising a weight vector, the weight vector comprising a weight for each feature of a plurality of features associated with a collection of items, the collection including the first plurality of items presented to the user; and selecting, by the at least one computing device, a second plurality of items to be presented in the user interface, the second plurality of items identified as offering a larger gain in knowledge from user item labeling input relative to those unidentified ones from the collection of items.

In accordance with one or more embodiments a system is provided, which system comprises at least one computing device comprising one or more processors to execute and memory to store instructions to receive, via a user interface, user item labeling input in response to a first plurality of items presented in the user interface and indicating a user's preference for a selected item relative to each other item of the first plurality; learn a preference scoring function comprising a weight vector, the weight vector comprising a weight for each feature of a plurality of features associated with a collection of items, the collection including the first plurality of items presented to the user; and select a second plurality of items to be presented in the user interface, the second plurality of items identified as offering a larger gain in knowledge from user item labeling input relative to those unidentified ones from the collection of items.

In accordance with yet another aspect of the disclosure, a computer readable non-transitory storage medium is provided, the medium for tangibly storing thereon computer readable instructions that when executed cause at least one processor to receive, via a user interface, user item labeling input in response to a first plurality of items presented in the user interface and indicating a user's preference for a selected item relative to each other item of the first plurality; learn a preference scoring function comprising a weight vector, the weight vector comprising a weight for each feature of a plurality of features associated with a collection of items, the collection including the first plurality of items presented to the user; and select a second plurality of items to be presented in the user interface, the second plurality of items identified as offering a larger gain in knowledge from user item labeling input relative to those unidentified ones from the collection of items.

In accordance with one or more embodiments, a system is provided that comprises one or more computing devices configured to provide functionality in accordance with such embodiments. In accordance with one or more embodiments, functionality is embodied in steps of a method performed by at least one computing device. In accordance with one or more embodiments, program code to implement functionality in accordance with one or more such embodiments is embodied in, by and/or on a computer-readable medium.

### DRAWINGS

The above-mentioned features and objects of the present disclosure will become more apparent with reference to the following description taken in conjunction with the accompanying drawings wherein like reference numerals denote like elements and in which:

FIG. 1 provides an overview of an iterative process of determining a scoring function in accordance with one or more embodiments of the present disclosure.

FIG. 2 provides an example of a user interface presenting items for comparative annotation in accordance with one or more embodiments of the present disclosure.

FIG. 3 provides an example of features that may be identified for items in accordance with one or more embodiments of the present disclosure.

FIG. 4 illustrates weight vectors in a feature space in accordance with one or more embodiments that may be used to determine the ordering of items.

FIG. 5 provides some examples of items and corresponding ordering and preference scores in accordance with one or more embodiments of the present disclosure.

FIG. 6 illustrates some components that can be used in connection with one or more embodiments of the present disclosure.

FIG. 7 is a detailed block diagram illustrating an internal architecture of a computing device in accordance with one or more embodiments of the present disclosure.

### DETAILED DESCRIPTION

Subject matter will now be described more fully hereinafter with reference to the accompanying drawings, which form a part hereof, and which show, by way of illustration, specific example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

Throughout the specification and claims, terms may have nuanced meanings suggested or implied in context beyond an explicitly stated meaning likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

The detailed description provided herein is not intended as an extensive or detailed discussion of known concepts, and as such, details that are known generally to those of ordinary skill in the relevant art may have been omitted or may be handled in summary fashion.

In general, the present disclosure includes a preference learning system, method and architecture. Certain embodiments of the present disclosure will now be discussed with reference to the aforementioned figures, wherein like reference numerals refer to like components.

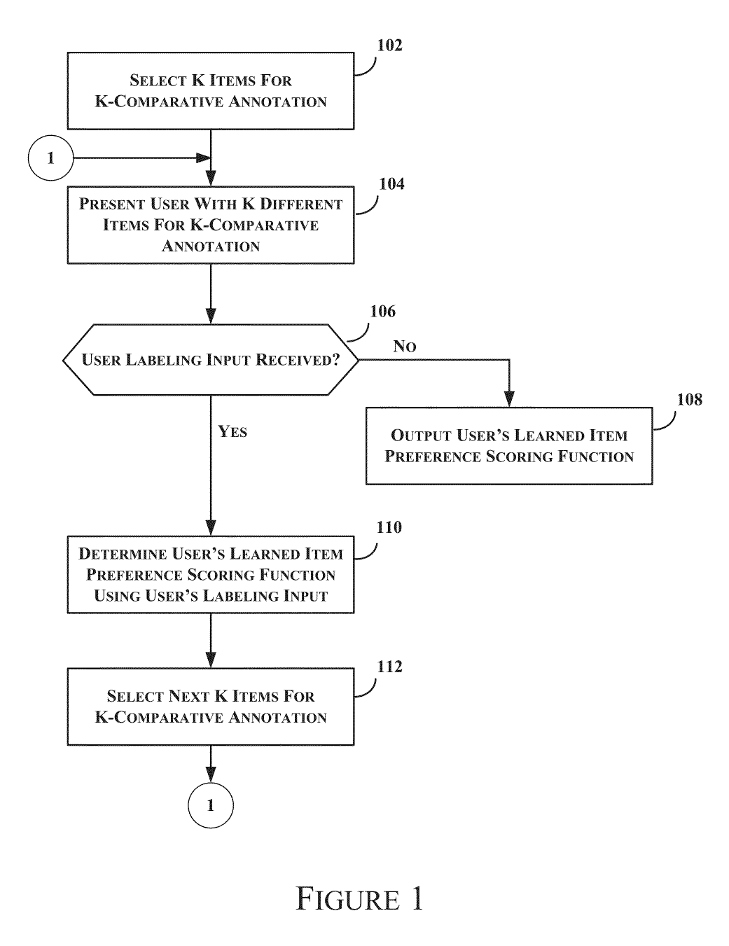

In accordance with one or more such embodiments a user's item preference(s) are learned using input provided by the user concerning one or more set of items, each set comprising k items, presented to a user in an iterative process. The user is asked to provide a relative preference, e.g., the user is asked to identify an item in a set of k items that the user prefers relative to the other items in the set. The relative labeling input may then be used to generate item training pairs, which may be used to determine a preference scoring function, which scoring function may be used to order, or rank, items in accordance with their relative scores. FIG. 1 provides an overview of an iterative process of determining a scoring function in accordance with one or more embodiments of the present disclosure.

At step 102, a number, k, of items are selected for a k-comparative annotation. By way of a non-limiting example, using an interactive user interface, the user is presented with k items and asked to identify, e.g., select, one of the items in a set items that the user prefers over the other items in the set. By way of some further non-limiting examples, the user may be asked to select the user's favorite, or most preferred, item of the items in the set presented to the user in the user interface. At step 104, the k items are presented to the user for annotation.

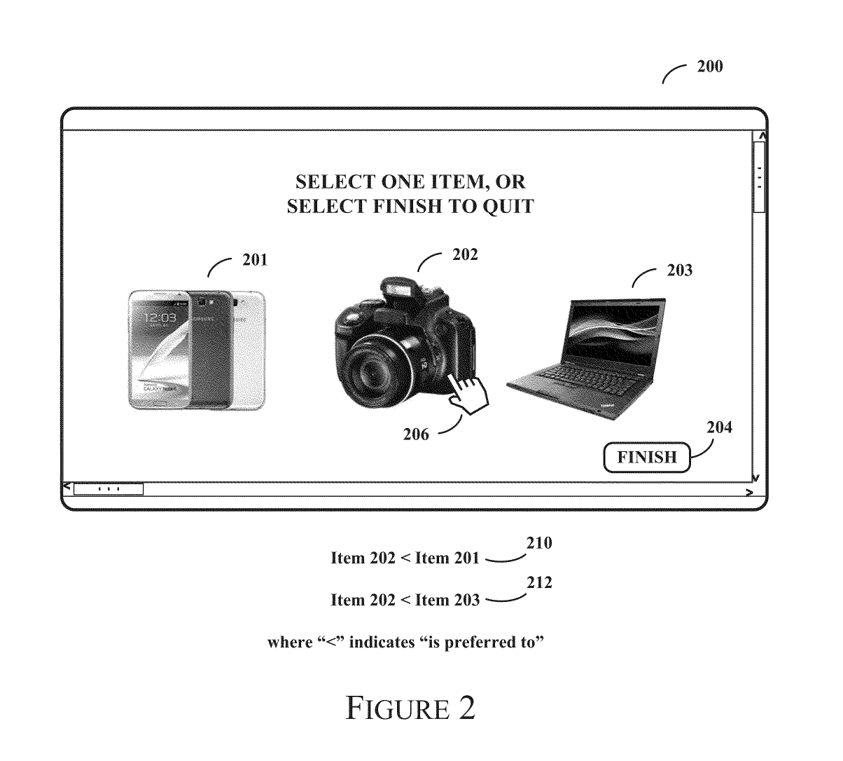

FIG. 2 provides an example of a user interface presenting items for comparative annotation in accordance with one or more embodiments of the present disclosure. In the non-limiting example provided in FIG. 2, user interface 200 includes three items, i.e., where k is equal to 3, items 201, 202 and 203. In the example, the user is asked to select one of the three items as being preferred relative to the other two. As shown in the example, the user may quit the process at any time by selecting the finish button 204. As indicated by the cursor 206 in the example of FIG. 2, the user selects item 202, which is at least indicative of the user's preference of a digital camera over items 201 and 203, i.e., a smart phone and a laptop computer. In other words, item 202 is preferred by the user relative to items 201 and 203.

In contrast to approaches whereby the user must indicate a like/dislike for each of a number of items or whereby the user must indicate a number from a ratings scale for each of a number of items, embodiments of the present disclosure use a comparative annotation whereby the user is able to select one item from a set of items, which selection may be used to learn the user's preference with regard to each item in the set relative to each other. This eliminates the need for the user to have to provide separate input for each item, where each input is either a simple binary input, e.g., like/dislike, or a more complicated multi-valued ratings scale. In accordance with one or more embodiments, the item labeling input provided by the user provides information about all of the items in the set based on the user's selection of one of the items in the set. Furthermore, learning from the labeling input received from the user in accordance with one or more embodiments may be based on relative item preferences rather than an explicit binary or multi-valued ratings scale.

In accordance with one or more embodiments of the present disclosure, the comparative annotation, in which the user selects a single item in the set of items, indicates that the selected item is preferred to each of the other items not selected in the set of items. The resulting comparative annotation may be specified using the “<” symbol, which indicates that the item to the left of the “<” symbol “is preferred to” the item to the right of the “<” symbol. The comparative annotation resulting from selection of item 202 is that the user prefers a camera to a smart phone and that the user prefers a camera to a laptop computer. The input received from the user may be used to generate training pairs, each of which comprises a pairing of items, such as training pairs 210 and 212 of FIG. 2. The training pairs 210 and 210 generated from a user's labelling, or annotation, input may be used to learn a preference scoring function for the user, which function may be used to generate an item preference score for the user.

It should be apparent that the number k of items included in a k-comparative annotation may be any value. The larger the value, the more training pairs that may be generated from each iteration, or from each input received from the user; however, a larger value of k may result in less differentiation between, or articulation of, a user's relative preferences. Too large a value for k might make is more difficult for the user to review and select one that is preferred relative to the other items presented. The smaller the value of k, the greater the number of rounds that might be needed to accurately identify a preference scoring function for the user.

Referring again to FIG. 1, a determination is made at step 106 whether or not labeling input is received from the user, e.g., a determination is made whether or not item selection input is received from the user. If it is determined that item selection input is received, processing continues at step 110 to determine, or learn, a preference scoring function fir the user using the user's labeling input. In a case that the received item selection input is the first such input received, the preference scoring function may be determined using the single item selection input. However, where multiple item selection input, via more than one iteration, have been received from the user, e.g., the user has selected an items from multiple sets of items, the item selection input received thus far may be used to determine the user's preference scoring function.

At step 112 of FIG. 1, a new set of k items is selected for another k-comparative annotation, and processing continues at step 104 to present the new set of k items. If the user selects one of the items in this new set of items, the user's preference scoring function may be determined. The preference scoring function determined for the user in response to the user's last item selection input, and any previous item selection input, becomes the user's learned item preference scoring function.

The user may continue labeling until the user wishes to end the process. Each time the user provides labeling input, a preference scoring function may be generated that uses the labeling input received from the user thus far. The user may end the comparative annotation process. In the example of FIG. 2, the user may click on the finish button 204.

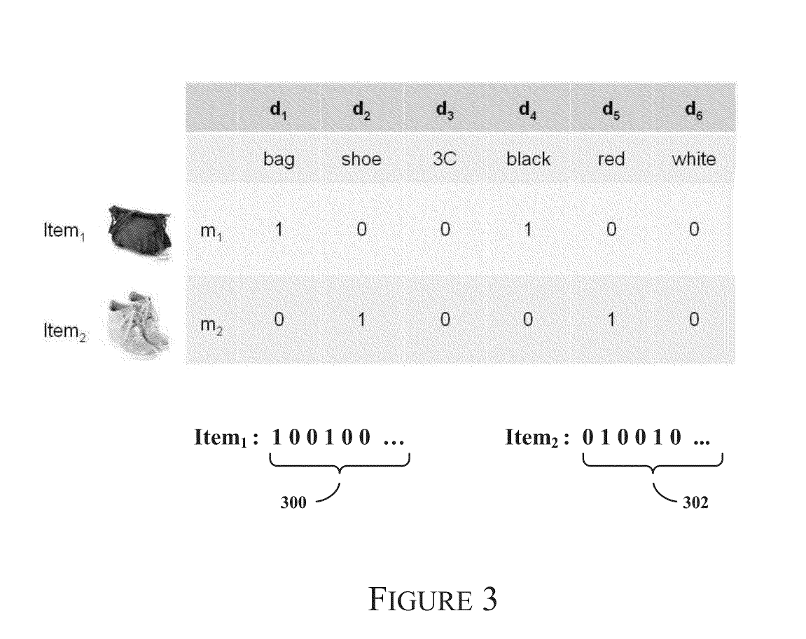

In accordance with one or more embodiments, a set of features is determined for items. FIG. 3 provides an example of features that may be identified for items in accordance with one or more embodiments of the present disclosure. In the non-limiting example of FIG. 3, six features and two items are shown. Of course, it should be apparent that there may be any number of features as well as any number of items. In the example of FIG. 3, a value of zero or one is given for a given feature and item based on whether or not the item has the feature, e.g., a value of “1” indicating that the item has the feature and a value of “0” indicating that the item lacks the feature. And item's feature values may be concatenated to form a feature vector, such as vectors 300 and 302 corresponding to the two items shown in FIG. 3. In accordance with one or more embodiments, the preference scoring, or ranking, function comprises a weighting for each item feature, which weighting is learned based on the user's labeling input. A weight assigned to a feature may represent the importance of the feature to the user, which importance is determined based on the item selection input received from the user.

In the k-comparative annotation process, the first set of items selected for the k-comparative annotation, e.g., at step 102 of FIG. 1, may be randomly selected, and for each next k-comparative annotation iteration, each item selected for inclusion in the set of items for annotation, e.g., at step 112 of FIG. 1, may be selected based on a determined measure of knowledge gained by including the item in the set.

In accordance with one or more embodiments, the knowledge gained may be a value determined for each item, or for each item not yet included in a k-comparative annotation iteration. By way of a non-limiting example, the k items selected for a set of items presented to the user may be selected from a collection of items. Each item in the collection may be assigned a knowledge gain score, which may be compared against the score determined for each other item in the collection, such that the k items included in the set of items to be presented to the user have the highest knowledge gain scores relative to the knowledge gain scores associated with the items not selected. An item's knowledge gain score may be said to indicate the degree or amount of knowledge that may be gained if the item is included in the set of items. In accordance with one or more embodiments, the item selection may also be based on whether an item has already been labeled, e.g., already been included in a previous set of items for which user input was received. There may be little if any knowledge gained from a previously labeled item. Thus, the collection of items from which the set of items are selected may be those items that have yet to be “labeled” by the user in a k-comparative annotation iteration.

The preference scoring function learned using the labeling input provided by the user may be used to rank “unlabeled” items. By way of a non-limiting example, the preference scoring function may generate a preference score for any item based on the item's features and the function's weighting vector, which comprises a corresponding weight for each of the item's features. An item's preference score may be compared to other items' preference scores. Identification of a user's preferred item(s) may be used in any number of applications, including without limitation in making item recommendations to a user, personalizing a user's user interface, targeted advertising, etc.

Embodiments of the present disclosure may use any technique now known or later developed for learning a user's preference scoring function. In accordance with one or more embodiments, a preference learner learns from the user's known personal preferences and may make inferences about unknown preferences of the user using the user's known preferences. In accordance with one or more such embodiments, the user's known preferences are provided using the user's labelling input in response to one or more k items sets presented to the user. In accordance with one or more embodiments, the preference learner generates a preference scoring function that using the user's labelling input. By way of a non-limiting example, a preference scoring function may be expressed as:

$$PF ( item\_x ) = \frac{1}{z} \vec{w} Φ ( {m}_{i} ) , \qquad Equation ( 1 )$$

where Φ(mᵢ) is a mapping of the item onto a feature space, item_x, using the item's features, which may be represented by feature vector, mᵢ, and \vec{w} is a vector of weights comprising a corresponding weight for each feature in feature vector, mᵢ. In accordance with one or more embodiments, a preference score, PF(item_x), for an item, itemₓ, generated using the preference scoring function learned for the user. By way of a non-limiting example, the preference score may be a product of the preference scoring function's weight vector and the item's feature vector, mᵢ. In accordance with one or more embodiments, the item's preference score may be normalized using a normalization factor, such as

$$\frac{1}{z} .$$

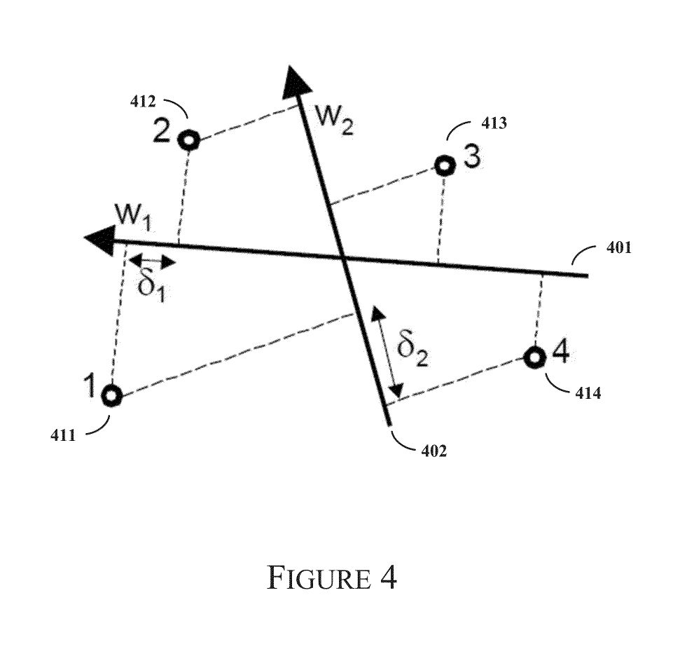

FIG. 4 illustrates weight vectors in a feature space in accordance with one or more embodiments that may be used to determine the ordering of items. In the example, items 411-414 are mapped onto a feature space using each item's features and vectors 401 and 402 represent two weight vectors. Vector 401 might represent the user's actual, preferred item ordering; e.g., 411, 412, 413 and 414. Such ordering may be based on each item's projection onto vector 401 or, equivalently, by each item's signed distance to a hyperplane with normal vector \vec{w}, or vector 401. The item ordering associated with vector 402 is 412, 413, 411 and 414, which ordering may be determined in a manner similar to that used to determine the item ordering with respect to vector 401.

Embodiments of the present disclosure may use labeling input received from the user to learn a weight vector that aligns more closely with vector 401. As discussed below, embodiments of the present disclosure use labeling input received from the user to determine an item ordering that maximizes a number of concordant item pairings with respect to the user's actual, preferred ordering, such that a resulting feature weight vector may represent the user's actual, preferred feature weights.

In accordance with one or more embodiments, a weight vector may be determined for a user such that the items in a collection of items, e.g., a number of items each having a feature vector, may be ordered, or ranked, according to the user's preference. In accordance with one or more such embodiments, a learned weight vector is one that maximizes the number of concordant pairs, or maximizes Kendall's Tau. The following non-limiting example illustrates concordant pairs and Kendall's Tau, and assumes the following example of two item orderings or rankings:

item₁<item₂<item₃<item₄<item₅ Ordering, or Ranking (1)

item₃<item₂<item₁<item₄<item₅ Ordering, or Ranking (2)

Item ranking (1) is determined using a first weighting and item ranking (2) uses a second weighting. In the above example, it is assumed that item ranking (1) most closely reflects the user's actual, or target, item ordering and ranking (2) might be a learned order.

Breaking down item ranking (1) and item ranking (2) into pairs of items, the two rankings can be said to be in agreement, or concordance, with respect to the ordering of seven item pairs identified as follows (where “<” represents “is preferred to”): item₁<item₄, item₁<item₅, item₂<item₄, item₂<item₅, item₃<item₄, item₃<item₅ and item₄<item₅.

The above item pairs may be referred to as concordant pairs, the number of which may be represented as P. Conversely, item rankings (1) and (2) can be said to lack agreement, or be in discordance, with respect to the ordering of three item pairs. Ranking (1) has item₁<item₂, item₂<item₃ and item₁<item₃ and ranking (2) reverses the preferences, i.e., item₂<item₁, item₃<item₂ and item₃<item₁. The three pairs that lack concordance between rankings (1) and (2) may be referred to as discordant pairs, the number of which may be represented as Q. Kendall's Tau may be determined as follows:

$$\frac{P - Q}{P + Q} \qquad Equation ( 2 )$$

Using equation (2), Kendall's Tau for rankings (1) and (2) is 0.04, or (7−3)/(7+3).

In accordance with one or more embodiments, a weighting may be determined such that a preference scoring function that may be identified maximizes an expected Kendall's Tau, which may be achieved by maximizing the number of concordant pairs. In other words, an expected Kendall's Tau may be achieved as differences between an item ordering determined by a learned preference scoring function and a user's preferred/actual ordering of items are minimized. In accordance with one or more such embodiments, a ranking SVM leaning approach may be used to determine a learned preference scoring function. In accordance with one or more embodiments, such a maximization may be represented as:

$$min V ( \vec{w} , \vec{ξ} ) = \frac{1}{2} \vec{w} \cdot \vec{w} + C \sum {ξ}_{i , j , k} \qquad Equation ( 3 )$$

subject to:

$$∀ ( {f}_{i} , {f}_{j} ) ∈ {r}_{1}^{*} : \vec{w} Φ ( {m}_{i} ) \geq \vec{w} Φ ( {m}_{j} ) + 1 - {ξ}_{i , j , k}$$

$$…$$

$$∀ ( {f}_{i} , {f}_{j} ) ∈ {r}_{n}^{*} : \vec{w} Φ ( {m}_{i} ) \geq \vec{w} Φ ( {m}_{j} ) + 1 - {ξ}_{i , j , n}$$

$$∀ i ∀ j ∀ k : {ξ}_{i , j , k} \geq 0$$

In equation (3), ƒᵢ and are items, r*ᵢ and r*ₙ are rankings or item orderings, \vec{w} is a vector of weights comprising a corresponding weight for each feature in an item's feature vector, m, ζ is a slack variable, and C is a parameter that provides a trade-off between margin size and training error, where margin size may be the distance between the closest two projections with the respect to the target rankings. By way of some non-limiting examples δ₁ and δ₂ shown in FIG. 4 represent two margin sizes. In accordance with one or more embodiments, equation (3) presents an optimization problem that may be considered to be equivalent to a classification of pairwise difference vectors Φ(mᵢ)−Φ(mⱼ). In accordance with at least one embodiment, the optimization problem may be solved using a RankSVM approach such as that described at http://en.wikipedia.org/wiki/Ranking_SVM, which may be implemented as described at http://www.cs.cornell.edu/people/tj/svm_light/svm_rank.html, both of which are incorporated herein by reference. Of course, it should be apparent that approaches other than RankSVM may be used to solve the optimization problem and/or that any such approach's implementation may be used without departing from the scope of embodiments of the present disclosure.

In accordance with one or more embodiments, a user's preference scoring function may be determined iteratively and after each iteration in which a user provides labeling input, e.g., labeling input received in response to presenting the user with k different items for comparison and annotation at step 104 of FIG. 1. In accordance with one or more such embodiments, after the user's preference scoring function is determined using the user's labelling input received thus far, a next set of k items may be selected for presentation to the user to elicit additional labeling input from the user, e.g., see step 112 of FIG. 1.

In accordance with one or more embodiments, a set of k items is selected for the next round, or iteration. In accordance with one or more such embodiments, the k items may be selected that provide a statistically optimal way to collect data, e.g., user preference data, for use in learning a user's preference scoring function. By way of a non-limiting example, the k items may be selected based on measures of uncertainty and representativeness determined fix each item from which the k items are to be selected. In accordance with one or more embodiments, the measures of uncertainty and representativeness may be determined for labeled and unlabeled items. In accordance with one or more embodiments, the measures may be determined for unlabeled items, or those items that have yet to be labeled by the user in connection with a set of items selected for k-collaborative annotation.

In accordance with at least one embodiment, a degree of uncertainty associated with an item may be represented by an uncertainty measure, which may be an estimate of how much information an item, e.g., an unlabeled item, might provide to preference learning upon receiving labeling input for the item from the user. In other words, if uncertainty, or lack of confidence, about a user's preference relative to an item is high, the item's inclusion in a set of items for k-collaborative annotation provides an opportunity to receive the user's labeling input for the item and reduce uncertainty by learning the user's preference(s) relative to the item. By way of a non-limiting example, an uncertainty measure, U_{ct}, for an item, itemₓ, may be determined using the item's preference scoring function, which is learned using the user's input relative to labeled items, as follows:

U_{ct}(itemₓ)=−PF(itemₓ)log PF(itemₓ)−(1−PF(itemₓ))log(1−PF(itemₓ)) Equation (4)

In accordance with at least one embodiment, a measure of an item's representativeness may be indicative of a probability density of the item at its position in feature space. In other words, it is beneficial to select the item that is likely to provide the most information about the user's preference(s). Assuming for the sake of example that two unlabeled items are being analyzed to determine which of the two should be included in a k set of items and the first item is positioned in a densely populated area of the feature space and the second item is positioned in a sparsely, or at least less densely, populated area of the feature space, inclusion of the first item in the k items for labeling by the user is more likely to provide the preference learner with a greater amount of information than the second item. In such a case, the user's labeling input relative to the first item may be said to be more representative, or indicative of the user's preference(s), than would the user's labeling input relative to the second item. In view of this assumption, an item's representativeness may be determined using a probability density of the item at its position in feature space. By way of a non-limiting example, an item's representative measure based on a probability density may be defined to be an average similarity between the item, e,g., an unlabeled item, and its neighboring items, where similarity may be determined using the features of the item and the features of its neighboring items, e.g., using a distance function. By way of a further non-limiting example, a representative measure, Rep(itemₓ), for an item, itemₓ, may be determined as follows:

$$Rep ( {item}_{x} ) = \frac{1}{\vert {C}_{i} \vert} {\sum }_{{item}_{y} ∈ {C}_{i}} exp ( - Dist ( {item}_{y} ) ) , \qquad Equation ( 5 )$$

where |Cᵢ| is a count of the number of items in a collection of neighboring items, Cᵢ, and Dist( ) is a distance function determining a similarity score between itemₓ and a neighboring item, item_{y}, in the collection of neighboring items. In accordance with one or more embodiments, a similarity score may be determined by Dist( ) representing a similarity between the features of itemₓ and the features of item_{y}, and a similarity score may be determined for each item_{y} in the collection relative to itemₓ.

In accordance with one or more embodiments, a measure of, or estimate of, knowledge that may be gained from the user's labeling input for an item being analyzed for inclusion in the next k selected items may be determined by combining the item's uncertainty and representative measures, e,g., which uncertainty and representative measures may be determined using equations (4) and (5), respectively. By way of a non-limiting example, an item's uncertainty and representative measures may be combined as follows:

KG(itemₓ)=v_{kg}U_{ct}(itemₓ)+(1−v_{kg})Rep(itemₓ) Equation (6)

In the above example, an optional accuracy measure, v_{kg}, is used.

In accordance with at least one embodiment, a knowledge gain measure, KG, may be determined for each item in a database of items, e.g., all of the items for which a feature set has been defined, using equation (6), the items may then be ranked relative to each other using each item's knowledge gain measure, and the k items with the highest knowledge gain measure, relative to the knowledge gain measures of the other items, that have yet to be labeled, or annotated, by the user may be selected as the next k items for k-comparative annotation, or labeling. Referring again to FIG. 1, the selection of k items for the k-comparative annotation may be performed in connection with step 112 as well as step 102. Alternatively, the k items selected at step 102 might be selected randomly. Of course, any technique may be used to select a set of items in step 102 and/or step 112, including a random selection of items.

In accordance with one or more embodiments, an iterative process in which the user is presented with a set of k items for annotation may continue so as to collect information about the user's relative preferences, e.g., item and/or feature preferences, to thereby refine the user's preference score function while the user continues to provide the labeling input.

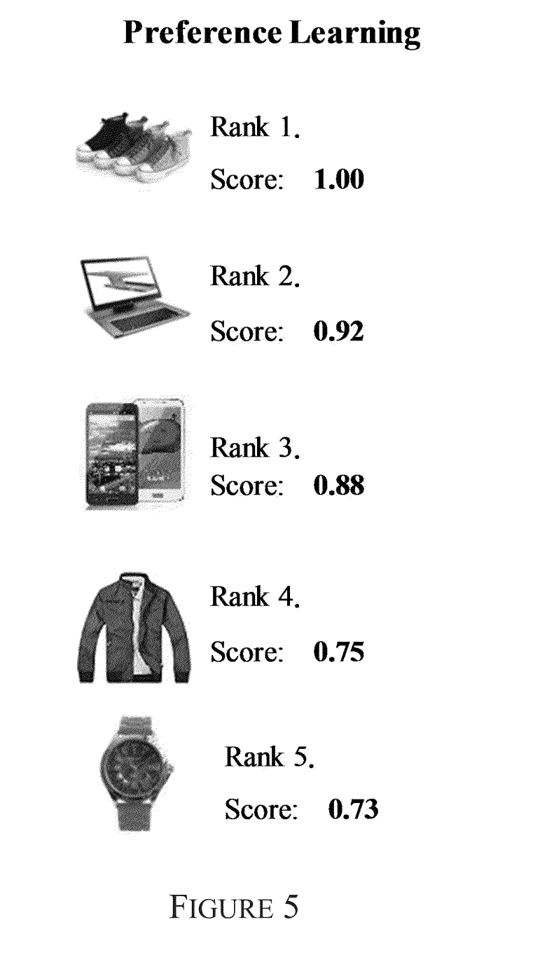

FIG. 5 provides some examples of items and corresponding ordering and preference scores in accordance with one or more embodiments of the present disclosure. In the example of FIG. 5, the items comprise merchandise, e.g., apparel and devices. It should be apparent that any item or type of item for which features may be identified may be used with embodiments of the present disclosure, including without limitation any type of content, such as audio, video, multimedia, audio and/or video streams, images, songs, albums, artists, documents, articles, etc., as well as products, merchandise, etc.

In the example shown in FIG. 5, the items are ordered in accordance with, and/or relative to, the preference score determined for each item using a user's preference scoring function and each item's associated features. Thus, shoes, which are determined to have a preference score of 1.00, have the highest ranking, e.g., a ranking of 1, a computing device with a preference score of 0.92 is the second highest ranked item, e.g., a ranking of 2, etc.

In accordance with one or more embodiments, each item's preference score shown in FIG. 5 may be determined using the item's feature vector and the feature weights, e.g., the weight vector \vec{w}, and preference scoring function learned using the labeling input received from the user. Thus and by way of a non-limiting example, assuming that there have been four k-comparative annotations input by the user, e.g., four rounds of item labeling input by the user, the weight vector \vec{w} and the preference scoring function, from which each item's preference score may be generated, may be based on the four sets of item labelling input received from the user. If the user provides additional item labelling input, e.g., in a fifth, sixth, etc. round, the weight vector \vec{w} and the preference scoring function, from which each item's preference score may be generated, may be updated using the additional labeling input.

In accordance with one or more embodiments, items may be grouped into categories and/or subcategories of categories. Based on the items a user has labeled, the user's preference may be interred at any level of a hierarchy, which may comprise an item level, one or more subcategory levels and one or more category levels.

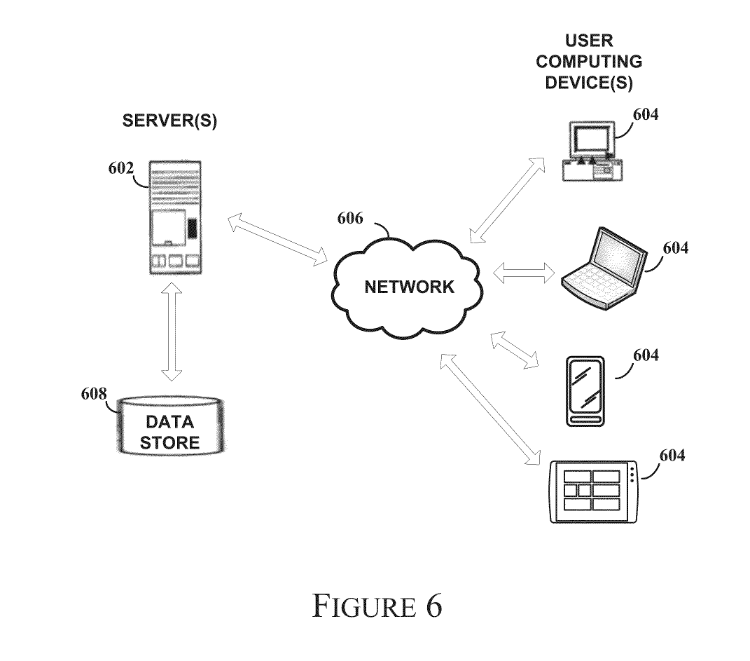

FIG. 6 illustrates some components that can be used in connection with one or more embodiments of the present disclosure. In accordance with one or more embodiments of the present disclosure, one or more computing devices, e.g., one or more servers, user devices or other computing device, are configured to comprise functionality described herein. For example, a computing device 602 can be configured to execute program code, instructions, etc. to provide functionality in accordance with one or more embodiments of the present disclosure.

Computing device 602 can serve content to user computing devices 604 using a browser application via a network 606. Data store 608 can be used to store an item database, which may comprise item data such as feature data and/or user data such as item labeling data, weight vector and/or item preference scores for one or more users. Data store 608 may also store program code to configure a server 602 in accordance with one or more embodiments of the present disclosure.

The user computing device 604 can be any computing device, including without limitation a personal computer, personal digital assistant (PDA), wireless device, cell phone, internet appliance, media player, home theater system, and media center, or the like. For the purposes of this disclosure a computing device includes a processor and memory for storing and executing program code, data and software, and may be provided with an operating system that allows the execution of software applications in order to manipulate data. A computing device such as server 602 and the user computing device 604 can include one or more processors, memory, a removable media reader, network interface, display and interface, and one or more input devices, e.g., keyboard., keypad, mouse, etc. and input device interface, for example. One skilled in the art will recognize that server 602 and user computing device 604 may be configured in many different ways and implemented using many different combinations of hardware, software, or firmware.

In accordance with one or more embodiments, a computing device 602 can make a user interface available to a user computing device 604 via the network 606. The user interface made available to the user computing device 604 can include content items, or identifiers (e.g., URLs) selected for the user interface in accordance with one or more embodiments of the present invention. In accordance with one or more embodiments, computing device 602 makes a user interface available to a user computing device 604 by communicating a definition of the user interface to the user computing device 604 via the network 606. The user interface definition can be specified using any of a number of languages, including without limitation a markup language such as Hypertext Markup Language, scripts, applets and the like. The user interface definition can be processed by an application executing on the user computing device 604, such as a browser application, to output the user interface on a display coupled, e.g., a display directly or indirectly connected, to the user computing device 604.

In an embodiment the network 606 may be the Internet, an intranet (a private version of the Internet), or any other type of network. An intranet is a computer network allowing data transfer between computing devices on the network. Such a network may comprise personal computers, mainframes, servers, network-enabled hard drives, and any other computing device capable of connecting to other computing devices via an intranet. An intranet uses the same Internet protocol suit as the Internet. Two of the most important elements in the suit are the transmission control protocol (TCP) and the Internet protocol (IP).

As discussed, a network may couple devices so that communications may be exchanged, such as between a server computing device and a client computing device or other types of devices, including between wireless devices coupled via a wireless network, for example. A network may also include mass storage, such as network attached storage (NAS), a storage area network (SAN), or other forms of computer or machine readable media, for example. A network may include the Internet, one or more local area networks (LANs), one or more wide area networks (WANs), wire-line type connections, wireless type connections, or any combination thereof. Likewise, sub-networks, such as may employ differing architectures or may be compliant or compatible with differing protocols, may interoperate within a larger network. Various types of devices may, for example, be made available to provide an interoperable capability for differing architectures or protocols. As one illustrative example, a router may provide a link between otherwise separate and independent LANs. A communication link or channel may include, for example, analog telephone lines, such as a twisted wire pair, a coaxial cable, full or fractional digital lines including T1, T2, T3, or T4 type lines, Integrated Services Digital Networks (ISDNs), Digital Subscriber Lines (DSLs), wireless links including satellite links, or other communication links or channels, such as may be known to those skilled in the art. Furthermore, a computing device or other related electronic devices may be remotely coupled to a network, such as via a telephone line or link, for example.

A wireless network may couple client devices with a network. A wireless network may employ stand-alone ad-hoc networks, mesh networks, Wireless LAN (WLAN) networks, cellular networks, or the like. A wireless network may further include a system of terminals, gateways, routers, or the like coupled by wireless radio links, or the like, which may move freely, randomly or organize themselves arbitrarily, such that network topology may change, at times even rapidly. A wireless network may further employ a plurality of network access technologies, including Long Term Evolution (LTE), WLAN, Wireless Router (WR) mesh, or 2nd, 3rd, or 4th generation (2G, 3G, or 4G) cellular technology, or the like. Network access technologies may enable wide area coverage for devices, such as client devices with varying degrees of mobility, for example. For example, a network may enable RF or wireless type communication via one or more network access technologies, such as Global System for Mobile communication (GSM), Universal Mobile Telecommunications System (UMTS), General Packet Radio Services (GPRS), Enhanced Data GSM Environment (EDGE), 3GPP Long Term Evolution (LTE), LTE Advanced, Wideband Code Division Multiple Access (WCDMA), Bluetooth, 802.11b/g/n, or the like. A wireless network may include virtually any type of wireless communication mechanism by which signals may be communicated between devices, such as a client device or a computing device, between or within a network, or the like,

Signal packets communicated via a network, such as a network of participating digital communication networks, may be compatible with or compliant with one or more protocols. Signaling formats or protocols employed may include, for example, TCP/IP, UDP, DECnet, NetBEUI, IPX, Appletalk, or the like. Versions of the Internet Protocol (IP) may include IPv4 or IPv6. The Internet refers to a decentralized global network of networks. The Internet includes local area networks (LANs), wide area networks (WANs), wireless networks, or long haul public networks that, for example, allow signal packets to be communicated between LANs. Signal packets may be communicated between nodes of a network, such as, for example, to one or more sites employing a local network address. A signal packet may, for example, be communicated over the Internet from a user site via an access node coupled to the Internet. Likewise, a signal packet may be forwarded via network nodes to a target site coupled to the network via a network access node, for example. A signal packet communicated via the Internet may, for example, be routed via a path of gateways, servers, etc. that may route the signal packet in accordance with a target address and availability of a network path to the target address.

It should be apparent that embodiments of the present disclosure can be implemented in a client-server environment such as that shown in FIG. 6. Alternatively, embodiments of the present disclosure can be implemented with other environments. As one non-limiting example, a peer-to-peer (or P2P) network may employ computing power or bandwidth of network participants in contrast with a network that may employ dedicated devices, such as dedicated servers, for example; however, some networks may employ both as well as other approaches. A P2P network may typically be used for coupling nodes via an ad hoc arrangement or configuration. A peer-to-peer network may employ some nodes capable of operating as both a “client” and a “server.”

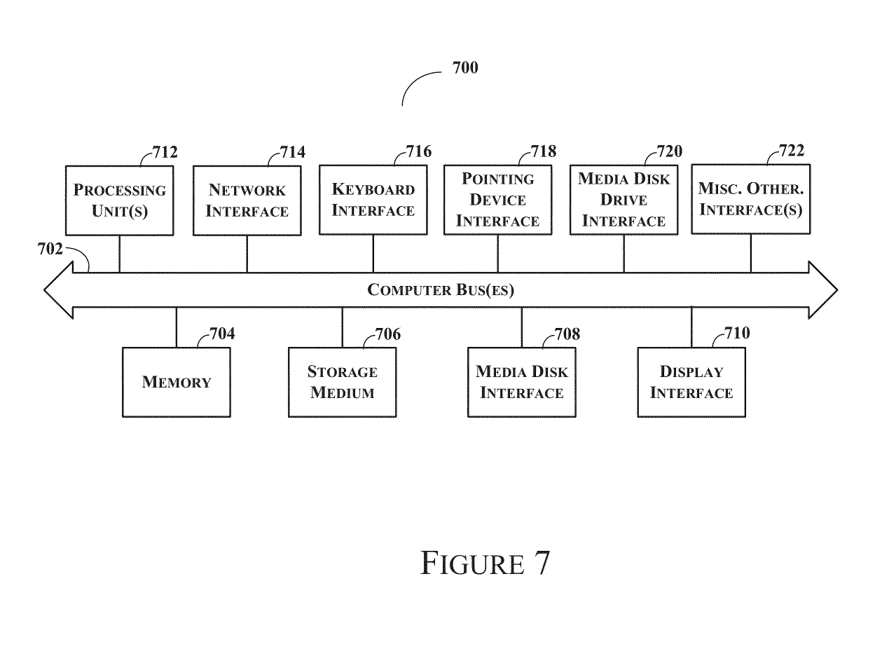

FIG. 7 is a detailed block diagram illustrating an internal architecture of a computing device, e.g., a computing device such as server 602 or user computing device 604, in accordance with one or more embodiments of the present disclosure. As shown in FIG. 7, internal architecture 700 includes one or more processing units, processors, or processing cores, (also referred to herein as CPUs) 712, which interface with at least one computer bus 702. Also interfacing with computer bus 702 are computer-readable medium, or media, 706, network interface 714, memory 704, e,g., random access memory (RAM), run-time transient memory, read only memory (ROM), etc., media disk drive interface 720 as an interface for a drive that can read and/or write to media including removable media such as floppy, CD-ROM, DVI), etc. media, display interface 710 as interface for a monitor or other display device, keyboard interface 716 as interface for a keyboard, pointing device interface 718 as an interface for a mouse or other pointing device, and miscellaneous other interfaces not shown individually, such as parallel and serial port interfaces, a universal serial bus (USB) interface, and the like.

Memory 704 interfaces with computer bus 702 so as to provide information stored in memory 704 to CPU 712 during execution of software programs such as an operating system, application programs, device drivers, and software modules that comprise program code, and/or computer-executable process steps, incorporating functionality described herein, e.g., one or more of process flows described herein. CPU 712 first loads computer-executable process steps from storage, e.g., memory 704, computer-readable storage medium/media 706, removable media drive, and/or other storage device. CPU 712 can then execute the stored process steps in order to execute the loaded computer-executable process steps. Stored data, e.g., data stored by a storage device, can be accessed by CPU 712 during the execution of computer-executable process steps.

Persistent storage, e.g., medium/media 706, can be used to store an operating system and one or more application programs. Persistent storage can also be used to store device drivers, such as one or more of a digital camera driver, monitor driver, printer driver, scanner driver, or other device drivers, web pages, content files, playlists and other files. Persistent storage can further include program modules and data files used to implement one or more embodiments of the present disclosure, e.g., listing selection module(s), targeting information collection module(s), and listing notification module(s), the functionality and use of which in the implementation of the present disclosure are discussed in detail herein.

For the purposes of this disclosure a computer readable medium stores computer data, which data can include computer program code that is executable by a computer, in machine readable form. By way of example, and not limitation, a computer readable medium may comprise computer readable storage media, for tangible or fixed storage of data, or communication media for transient interpretation of code-containing signals. Computer readable storage media, as used herein, refers to physical or tangible storage (as opposed to signals) and includes without limitation volatile and non-volatile, removable and non-removable media implemented in any method or technology for the tangible storage of information such as computer-readable instructions, data structures, program modules or other data. Computer readable storage media includes, but is not limited to, RAM, ROM, EPROM, EEPROM, flash memory or other solid state memory technology, CD-ROM, DVD, or other optical storage, magnetic cassettes, magnetic tape, magnetic disk storage or other magnetic storage devices, or any other physical or material medium which can be used to tangibly store the desired information or data or instructions and which can be accessed by a computer or processor.

Those skilled in the art will recognize that the methods and systems of the present disclosure may be implemented in many manners and as such are not to be limited by the foregoing exemplary embodiments and examples. In other words, functional elements being performed by single or multiple components, in various combinations of hardware and software or firmware, and individual functions, may be distributed among software applications at either the client or server or both. In this regard, any number of the features of the different embodiments described herein may be combined into single or multiple embodiments, and alternate embodiments having fewer than, or more than, all of the features described herein are possible. Functionality may also be, in whole or in part, distributed among multiple components, in manners now known or to become known. Thus, myriad software/hardware/firmware combinations are possible in achieving the functions, features, interfaces and preferences described herein. Moreover, the scope of the present disclosure covers conventionally known manners for carrying out the described features and functions and interfaces, as well as those variations and modifications that may be made to the hardware or software or firmware components described herein as would be understood by those skilled in the art now and hereafter.

While the system and method have been described in terms of one or more embodiments, it is to be understood that the disclosure need not be limited to the disclosed embodiments. It is intended to cover various modifications and similar arrangements included within the spirit and scope of the claims, the scope of which should be accorded the broadest interpretation so as to encompass all such modifications and similar structures. The present disclosure includes any and all embodiments of the following claims.

1. A method comprising:
receiving, by a computing device and via a user interface, user item labeling input in response to a first plurality of items presented in the user interface and indicating a user's preference for a selected item relative to each other item of the first plurality;
learning, by the at least one computing device, a preference scoring function comprising a weight vector, the weight vector comprising a weight for each feature of a plurality of features associated with a collection of items, the collection including the first plurality of items presented to the user; and
selecting, by the at least one computing device, a second plurality of items to be presented in the user interface, the second plurality of items identified as offering a larger gain in knowledge from user item labeling input relative to those unidentified ones from the collection of items.

2. The method of claim 1, selecting a second plurality of items to be presented in the user interface further comprising:
determining a knowledge gain measure for each item of at least a subset of items in the collection of items using a preference score determined for the item using the user's learned preference scoring function and the item's plurality of features.

3. The method of claim 2, determining a knowledge gain measure further comprising:
for each item of the at least a subset of items in the collection of items:
determining an uncertainty measure fur the item, the uncertainty measure comprises a measure of confidence about the user's preferences concerning the item;
determining a representativeness measure for the item, the representative measure comprises a measure of feature similarity of the item to other items in the collection; and
using the item's determined uncertainty and representativeness measures to determine the item's knowledge gain measure.

4. The method of claim 3, determining an uncertainty measure for the item further comprising:
determining a preference score for the item using the user's preference scoring function learned using the user's input relative to the first plurality of items; and
using the item's preference score to determine the item's uncertainty measure.

5. The method of claim 4, using the item's preference score to determine the item's uncertainty measure further comprising:
determining the uncertainty measure, U_{ct}, for the item, itemₓ, as follows:
U_{ct}(item)=−PF(itemₓ)log PF(itemₓ)−(1−PF(itemₓ))log(1−PF(itemₓ)), where PF(itemₓ) is the item's preference score determined using the user's preference scoring function.

6. The method of claim 3, determining a representativeness measure for the item further comprising:
determining a preference score for the item using the user's preference scoring function learned using the user's input relative to the first plurality of items; and
using the item's preference score to determine the item's representativeness measure.

7. The method of claim 6, using the item's preference score to determine the item's representativeness measure further comprising:
determining the representativeness measure, Rep(itemₓ), for the item, itemₓ, as follows:
$$Rep ( {item}_{x} ) = \frac{1}{\vert {C}_{i} \vert} {\sum }_{{item}_{y} ∈ {C}_{i}} exp ( - Dist ( {item}_{y} ) ) ,$$
where |Cᵢ| is a count of items in a plurality of neighboring items, Cᵢ, item_{y} represents a neighboring item in he plurality of neighboring items, and Dist(item_{y}) represents a similarity between itemₓ and item_{y} determined using a distance function and each item's features.

8. The method of claim 2, wherein the at least a subset of items comprises those items in the collection of items for which user item labeling input has yet to be received.

9. The method of claim 2, further comprising:
ranking, by the at least one computing device, the at least a subset of items based on each item's knowledge gain measure, the second plurality of items comprising a number, k, items having the highest knowledge gain measure relative the other ranked items.

10. A system comprising:
at least one computing device comprising one or more processors to execute and memory to store instructions to:
receive, via a user interface, user item labeling input in response to a first plurality of items presented in the user interface and indicating a user's preference for a selected item relative to each other item of the first plurality;
learn a preference scoring function comprising a weight vector, the weight vector comprising a weight for each feature of a plurality of features associated with a collection of items, the collection including the first plurality of items presented to the user; and
select a second plurality of items to be presented in the user interface, the second plurality of items identified as offering a larger gain in knowledge from user item labeling input relative to those unidentified ones from the collection of items.

11. The system of claim 10, the instructions to select a second plurality of items to be presented in the user interface further comprising instructions to:
determine a knowledge gain measure for each item of at least a subset of items in the collection of items using a preference score determined for the item using the user's learned preference scoring function and the item's plurality of features.

12. The system of claim 11, the instructions to determine a knowledge gain measure further comprising instructions to:
for each item of the at least a subset of items in the collection of items:
determine an uncertainty measure for the item, the uncertainty measure comprises a measure of confidence about the user's preferences concerning the item;
determine a representativeness measure for the item, the representative measure comprises a measure of feature similarity of the item to other items in the collection; and
use the item's determined uncertainty and representativeness measures to determine the item's knowledge gain measure.

13. The system of claim 12, the instructions to determine an uncertainty measure for the item further comprising instructions to:
determine a preference score for the item using the user's preference scoring function learned using the user's input relative to the first plurality of items; and
use the item's preference score to determine the item's uncertainty measure.

14. The system of claim 13, the instructions to use the item's preference score to determine the item's uncertainty measure further comprising instructions to:
determine the uncertainty measure, U_{ct}, for the item, itemₓ, as follows:
U_{ct}(itemₓ) =−PF(itemₓ)log PF(itemₓ)−(1−PF(itemₓ))log(1−PF(itemₓ)), where PP(itemₓ) is the item's preference score determined using the user's preference scoring function.

15. The system of claim 12, the instructions to determine a representativeness measure for the item further comprising instructions to:
determine a preference score for the item using the user's preference scoring function learned using the user's input relative to the first plurality of items; and
use the item's preference score to determine the item's representativeness measure.

16. The system of claim 15, the instructions to use the item's preference score to determine the item's representativeness measure further comprising instructions to:
determine the representativeness measure, Rep(itemₓ), for the item, itemₓ, as follows:
$$Rep ( {item}_{x} ) = \frac{1}{\vert {C}_{i} \vert} {\sum }_{{item}_{y} ∈ {C}_{i}} exp ( - Dist ( {item}_{y} ) ) ,$$
where |Cᵢ| is a count of items in a plurality of neighboring items, Cᵢ, item_{y} represents a neighboring item in the plurality of neighboring items, and Dist(item_{y})) represents a similarity between itemₓ and item_{y}, determined using a distance function and each item's features.

17. The system of claim 11, wherein the at least a subset of items comprises those items in the collection of items for which user item labeling input has yet to be received.

18. The system of claim 11, the instructions further comprising instructions to:
rank the at least a subset of items based on each item's knowledge gain measure, the second plurality of items comprising a number, k, items having the highest knowledge gain measure relative the other ranked items.

19. A computer readable non-transitory storage medium for tangibly storing thereon computer readable instructions that when executed cause at least one processor to:
receive, via a user interface, user item labeling input in response to a first plurality of items presented in the user interface and indicating a user's preference for a selected item relative to each other item of the first plurality;
learn a preference scoring function comprising a weight vector, the weight vector comprising a weight for each feature of a plurality of features associated with a collection of items, the collection including the first plurality of items presented to the user; and
select a second plurality of items to be presented in the user interface, the second plurality of items identified as offering a larger gain in knowledge from user item labeling input relative to those unidentified ones from the collection of items.

20. The computer readable non-transitory storage medium of claim 19, the instructions to select a second plurality of items to be presented in the user interface further comprising instructions to:
determine a knowledge gain measure for each item of at least a subset of items in the collection of items using a preference score determined for the item using the user's learned preference scoring function and the item's plurality of features.

21. The computer readable non-transitory storage medium of claim 20, the instructions to determine a knowledge gain measure further comprising instructions to:
for each item of the at least a subset of items in the collection of items:
determine an uncertainty measure for the item, the uncertainty measure comprises a measure of confidence about the user's preferences concerning the item;
determine a representativeness measure for the item, the representative measure comprises a measure of feature similarity of the item to other items in the collection; and
use the item's determined uncertainty and representativeness measures to determine the item's knowledge gain measure.

22. The computer readable non-transitory storage medium of claim 21, the instructions to determine an uncertainty measure for the item further comprising instructions to:
determine a preference score for the item using the user's preference scoring function learned using the user's input relative to the first plurality of items; and
use the item's preference score to determine the item's uncertainty measure.

23. The computer readable non-transitory storage medium of claim 22, the instructions to use the item's preference score to determine the item's uncertainty measure further comprising instructions to:
determine the uncertainty measure, U_{ct}, for the item, itemₓ, as follows:
U_{ct}(itemₓ)=−PF(itemₓ)log PF(itemₓ)−(1−PF(itemₓ))log(1−PF(itemₓ)), where PF(itemₓ) is the item's preference score determined using the user's preference scoring function.

24. The computer readable non-transitory storage medium of claim 21, the instructions to determine a representativeness measure for the item further comprising instructions to:
determine a preference score for the item using the user's preference scoring function learned using the user's input relative to the first plurality of items; and
use the item's preference score to determine the item's representativeness measure.

25. The computer readable non-transitory storage medium of claim 24, the instructions to use the item's preference score to determine the item's representativeness measure further comprising instructions to:
determine the representativeness measure, Rep(itemₓ), for the item, itemₓ, as follows:
$$Rep ( {item}_{x} ) = \frac{1}{\vert {C}_{i} \vert} {\sum }_{{item}_{y} ∈ {C}_{i}} exp ( - Dist ( {item}_{y} ) ) ,$$
where |Cᵢ| is a count of items in a plurality of neighboring items, Cᵢ, item_{y} represents a neighboring item in the plurality of neighboring items, and Dist(item_{y}) represents a similarity between itemₓ and item_{y} determined using a distance function and each item's features.

26. The computer readable non-transitory storage medium of claim 20, wherein the at least a subset of items comprises those items in the collection of items for which user item labeling input has yet to be received.

27. The computer readable non-transitory storage medium of claim 20, the instructions further comprising instructions to:
rank the at least a subset of items based on each item's knowledge gain measure, the second plurality of items comprising a number, k, items having the highest knowledge gain measure relative the other ranked items.
